(19) United States
(12) Patent Application Publication
(10) Pub. No.: US 2009/0148823 A1
(43) Pub. Date: Jun. 11, 2009

(54) SYSTEM, METHOD, AND COMPUTER PROGRAM PRODUCT FOR PROVIDING DISTRIBUTED LEARNING CONTENT

(75) Inventors: Ashok Pahwa, Rye Brook, NY (US); Norman Forbush, Baltimore, MD (US); Simon Buckland, Washington, DC (US); Duane Viazanko, Lutherville, MD (US)

Correspondence Address: VENABLE LLP, P.O. BOX 34385, WASHINGTON, DC, 20043-9998, US

(73) Assignee: Wall Street Institute, KFT, Kismaros (HU)

(21) Appl. No.: 11/950,822

(22) Filed: Dec. 5, 2007

(51) Int. Cl. G09B 5/00

(52) U.S. Cl. 434/307 R

(57) ABSTRACT

A system for assembling and distributing learning content to students via a delivery medium, such as the Internet, in a rich media format that provides for an interactive student learning experience. The learning content may have a varying size depending on the amount of delivery bandwidth available.

### BACKGROUND OF THE INVENTION

1. Field of the Invention

The present invention relates generally to educational content creation and delivery of educational content to students primarily over the Internet.

2. Related Art

Computer based training (CBT) systems are well known. Conventionally, distance learning CBT systems have been limited in their ability to reach a large audience due to bandwidth limitations. What is needed is an improved CBT system that overcomes shortcomings of conventional systems.

### SUMMARY OF VARIOUS EXEMPLARY EMBODIMENTS OF THE INVENTION

In an exemplary embodiment of the present invention a system, method and computer program product for assembling and distributing English language learning content to students via a delivery medium such as the Internet in a rich-media format that provides for an optimally rich and interactive student learning experience is disclosed. According to another exemplary embodiment, other language based learning content may be provided.

The content assembly system, according to an exemplary embodiment, may be used to develop one or more episodes that may meet impartially and externally defined didactic objectives. An exemplary episode may be developed. From the exemplary episode, grammar, vocabulary, and/or language function databases may be developed, which may include, according to an exemplary embodiment, using concordancing techniques that may build and/or structure the curriculum, and/or learning focus.

The content assembly system, according to an exemplary embodiment, may include, e.g., audio and/or visual content, and may be used to create and/or assemble such content.

To create audio content assets, according to an exemplary embodiment, voices may be recorded, where the voices may be based upon a script, audio recordings may be assembled and/or be coordinated to match the script, and/or sound effects and/or music may be added to produce a single sound track for the episode, according to an exemplary embodiment.

Creation of visual content assets and/or video content, according to an exemplary embodiment, may be achieved by, e.g., but not limited to, taking or capturing a photograph and/or image of, e.g., but not limited to, people, such as, e.g., but not limited to, a model. After capture, the photographs may be masked, foreground and/or background content may be captured, according to an exemplary embodiment. According to one exemplary embodiment, background and foreground images may be assembled prior to being distributed. According to an exemplary embodiment, image based content may be transmitted; content may be assembled for viewing (before and/or after transmission); and content may be displayed for viewing. According to an exemplary embodiment, foreground images may be placed and/or moved in front of background scene content, and/or the images may be moved relative to one another, and/or the movement may be performed so that the movements may match a script. Visual and/or audio content effects may be added, according to an exemplary embodiment. According to an exemplary embodiment, the foreground image may be moved relative to the background image. According to an exemplary embodiment, the entire sequence of delivery (including, e.g., but not limited to, movement, effects and other content) of an exemplary episode may be timed to match a script. According to an exemplary embodiment, visual content may be manipulated with relationship to, and/or in synchronization with, e.g., but not limited to, the script, and/or the audio content.

According to an exemplary embodiment, the audio assembly and/or visual components may be readied for delivery and/or transmission, by compressing the creative content assets. According to an exemplary embodiment, the content may be compressed to an optimal file size and quality level, and may be packaged for transmission. According to an exemplary embodiment, the content may be delivered over a network medium such as, e.g., but not limited to, a communications network such as, e.g., the Internet, etc. According to an exemplary embodiment, the content may be transmitted from an educational content service provider to, e.g., but not limited to, one or more students, for interactive viewing/training. According to an exemplary embodiment, appropriate learning units may be packaged and/or distributed to one or more students via a learning management system.

According to an exemplary embodiment, simulated real world experiences, in the form of episodes may be used to train the student in, e.g., but not limited to, language based skills such as, e.g., but not limited to, native and/or foreign language based skills including, e.g., but not limited to, grammar, vocabulary, interactions, and/or conversations, etc. For example, a student might be able to review an episode of content simulating a real world experience, such as, e.g., but not limited to, interviewing for a job, a person to person interaction, performing a sales call, interacting with a customer, and/or a person to person business interaction, etc.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of a content creation and/or distribution system according to an exemplary embodiment of the present invention;

FIG. 2 depicts an exemplary embodiment of a computer device that, according to an exemplary embodiment, may include, e.g., but not limited to, a processor, input/output devices, memory, storage and/or communications devices etc.;

FIG. 3 depicts an exemplary embodiment of an educational content creation, storage and database management system, according to an exemplary embodiment of the present invention;

FIG. 4 depicts an exemplary embodiment of a flowchart depicting an exemplary educational content delivery process flow, according to an exemplary embodiment of the present invention;

FIG. 5 depicts an exemplary embodiment of an exemplary educational content creation process flowt according to an exemplary embodiment of the present invention;

FIG. 6 depicts an exemplary embodiment of a diagram illustrating an exemplary process of foreground image content creation according to an exemplary embodiment of the present invention;

FIG. 7 depicts an exemplary embodiment of a diagram illustrating an exemplary process of background image content creation according to an exemplary embodiment of the present invention;

FIG. 8 depicts an exemplary embodiment of a diagram illustrating combining foreground image content to background image content, and illustrating basic animation by moving foreground images relative to background image based content, according to an exemplary embodiment of the present invention;

FIG. 9 depicts an exemplary embodiment of a diagram illustrating an exemplary learning cycle within which episodic educational language learning based content may be provided as one phase or a portion of the cycle, according to an exemplary embodiment of the present invention; and

FIG. 10 depicts an exemplary embodiment of a diagram illustrating the delivery of exemplary episodic educational language learning based content including providing of audio content and display of visual content, which may include movement of foreground image content relative to background image content including exemplary synchronized, interactive, episodic, audio-visual language content, depicted as graphed with respect to time.

### DETAILED DESCRIPTION OF VARIOUS EXEMPLARY EMBODIMENTS OF THE PRESENT INVENTION

Various exemplary embodiments of the invention including a preferred embodiment of the present invention may be discussed in detail below. While specific exemplary embodiments may be discussed, it should be understood that this may be done for illustration purposes only. A person skilled in the relevant art will recognize that other components and configurations can be used without parting from the spirit and scope of the invention.

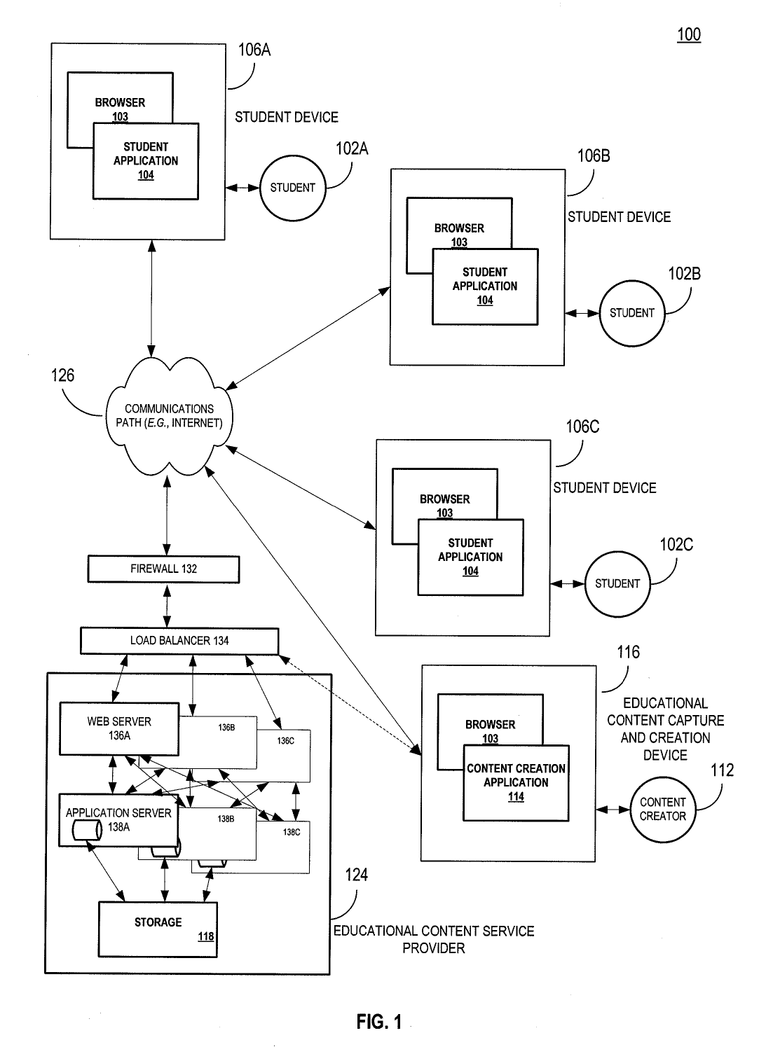

FIG. 1 depicts an exemplary embodiment of a diagram illustrating an exemplary high-level view of an exemplary episodic language educational content creation and distribution system 100 according to an exemplary embodiment of the present invention. According to an exemplary embodiment, an educational content service provider 124 may create, store and compress for transmission and/or distribution exemplary episodic language based educational content. According to an exemplary embodiment, the educational content service provider 124 may be used to distribute interactive multimedia content to one or more student devices 106A, 106B, 106C (collectively referred to 106), for interactive delivery for viewing by one or more students 102a, 102b, and 102c (collectively referred to 102). According to an exemplary embodiment, the system may be represented by a client-server network design where the educational content service provider 124 may include one or more servers including, e.g., but not limited to, web servers 136a-136c, application servers 138a-138c, coupled via load balancer 134 and firewall 132, as well as a communications network 126, and one or more student devices 106a, 106b, and 106c (collectively referred to as 106) are client devices, which according to an exemplary embodiment, may also include, in an exemplary embodiment, an educational content capture and/or creation device 116 for creating content for distribution. Clients 106 may be coupled to the educational service provider 124 via a communications path (e.g. the Internet). According to another exemplary embodiment (not shown), the exemplary episodic language educational content creation and distribution system 124 could be represented by any of a number of well-known hardware network architectures including, but not limited to, a peer-to-peer network design, a client-server based architecture, an application services (ASP) based offering, by which educational content may be distributed from one computing device to another (for a peer-to-peer embodiment, from student-to-student, for example). According to another exemplary embodiment (not shown), a standalone system may be also possible where the content may be distributed via a medium such as, e.g., a computer readable medium, such as, e.g., but not limited to, a compact disc read only memory (CD-ROM), and/or a digital versatile disk (DVD), etc. Any other hardware architecture such as, e.g., but not limited to, a services oriented architecture (SOA) by one skilled in the art could also be used.

As shown in FIG. 1, in an exemplary embodiment, a student device 106 may be coupled to an educational content service provider 124 via a network. In an exemplary embodiment, the student device 106 may be coupled to the education content service provider 124 via one or more devices including, e.g., but not limited to, a firewall 132, one ore more load balancers 134, one or more web servers 136, and one or more application servers 138, which may include, e.g., but not limited to, storage or may access a storage device 118. The devices may be coupled to one another over a network such as, e.g., but not limited to, the Internet. The educational content service provider 124, according to an exemplary embodiment, may include, one or more storage devices 118, including, one or more web servers 136, and/or one or more application servers 138, which may include storage or may access a storage device 118 such as a storage area network (SAN) device. The data storage device 118 may store files, such as, e.g., but not limited to, episodic language learning based educational content data files, such as, e.g., but not limited to, images, foreground images, background images, audio and/or script content, rich media data files, multimedia files, etc. In one embodiment, the storage device 118 may include a cluster of intelligent storage nodes.

In one embodiment, the storage device 118 may communicate with web servers 136a, 136b, 136c and browsers 103 on remote devices 106a, 106b, 106c (browsers 103 may include, e.g., but not limited to, Microsoft Internet Explorer, Netscape Navigator, Mozilla, FireFox, etc.) operating on end-user computer devices 106 via the standard Internet hypertext transfer protocol (“HTTP”) and universal resource locators (“URLs”). Although the use of HTTP is described herein, any well known transport protocol may be used without deviating from the spirit or scope of the invention. For the students 102 to access educational content, the end-users, through end-user computer devices 106, may generate hyper text transfer protocol (“HTTP”) requests to the content origin server 124 to obtain hyper text mark-up language (“HTML”) files. In addition, to obtain large data objects associated with those text files, the end-user, through end user computer devices 106, may generate HTTP requests (via browser 103) to the storage service device 118. For example, the end-user may download from the educational content service provider 124 servers 136, 138, educational content such as, e.g., but not limited to, episodic language learning based training content. When the user “clicks” to select a given URL, the educational content may be downloaded from the storage device 118 to the end-user device 116, for interactive access via browser 103, and/or student application 104, using an HTTP request generated by the browser 103 to the storage service device 118, and the storage service device 118 may then download the content to the end-user computer 106. The network 126 may permit storage of rich multimedia based episodic language learning content objects, and distribution over communications network path 126 to end user devices 106. Content may be created on an educational content capture and creation device 116 by a content author and/or creator 112 using the device 116, which may include, e.g., but not limited to one or more applications 114, and/or browser 103. In one exemplary embodiment, storage device 118 may include a storage cluster, which may include distributed systems technology that may harness the throughput of, e.g., but not limited to, hundreds of CPUs and storage of, e.g., but not limited to, thousands of disk drives. As shown in FIG. 1, education content file upload and download operations may be delivered via one or more load balancing fabric devices 134. In one exemplary embodiment, the load balancing fabric 134 may include a layer four (“L4”) switch. In general, L4 switches are capable of effectively prioritizing TCP and UDP traffic. In addition, L4 switches, which incorporate load balancing capabilities, may distribute requests for HTTP sessions among a number of resources, such as web servers 136a, 136b, 136c. For this exemplary embodiment, the load balancing fabric 134 may distribute upload and download requests to one of a plurality of web servers 136 based on availability. The load balancing capability in an L4 switch is currently commercially available.

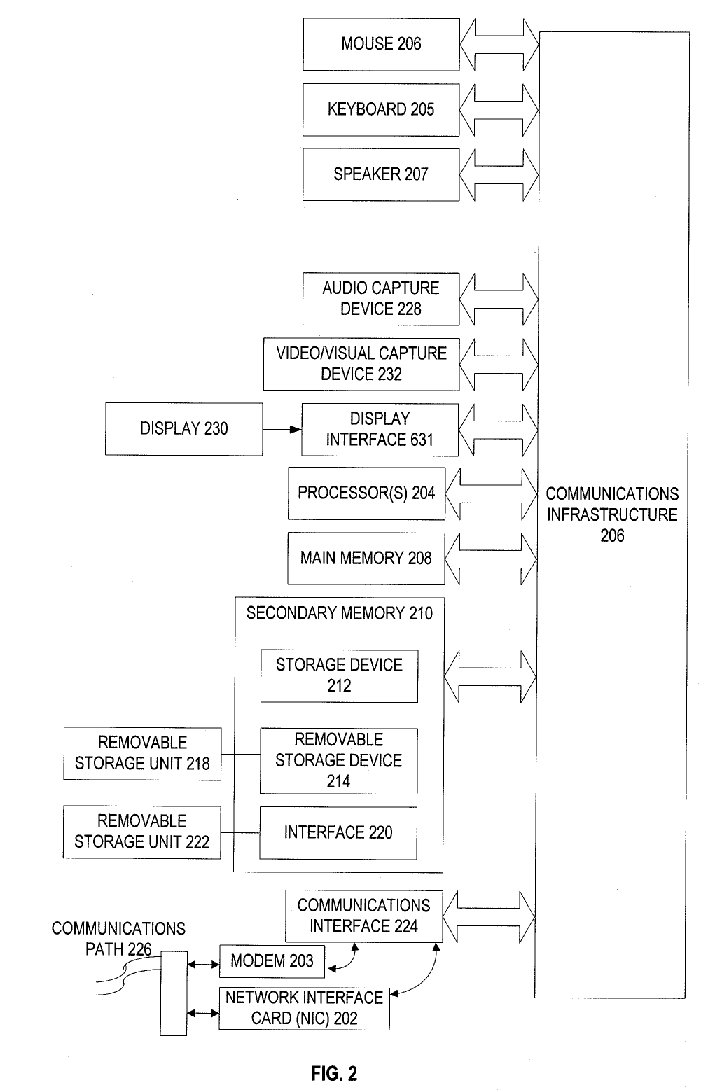

FIG. 2 depicts an exemplary computer system that may be used in implementing an exemplary embodiment of the present invention. Specifically, FIG. 2 depicts an exemplary embodiment of a computer system 200 that may be used in computing devices such as, e.g., but not limited to, a client and/or a server, etc., according to an exemplary embodiment of the present invention. FIG. 2 depicts an exemplary embodiment of a computer system that may be used as a student device 106, an educational content service provider 124, an educational content capture and creation device 116, a web server 136a, an application server 138, etc. The present invention (or any part(s) or function(s) thereof) may be implemented using hardware, software, firmware, and/or a combination thereof and may be implemented in one or more computer systems or other processing systems. In fact, in one exemplary embodiment, the invention may be directed toward one or more computer systems capable of carrying out the functionality described herein. An example of a computer system 200 is shown in FIG. 2, depicting an exemplary embodiment of a block diagram of an exemplary computer system useful for implementing the present invention. Specifically, FIG. 2 illustrates an example computer 200, which in an exemplary embodiment may be, e.g., (but not limited to) a personal computer (PC) system running an operating system such as, e.g., (but not limited to) MICROSOFT® WINDOWS® NT/98/2000/XP/CE/ME/VISTA/etc. available from MICROSOFT® Corporation of Redmond, Wash., U.S.A. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 200 is shown in FIG. 2. Other components of the invention, such as, e.g., (but not limited to) a computing device, a communications device, mobile phone, a telephony device, a telephone, a personal digital assistant (PDA), a personal computer (PC), a handheld PC, an interactive television (iTV), a digital video recorder (DVD), client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 2. Services may be provided on demand using, e.g., but not limited to, an interactive television (iTV), a video on demand system (VOD), via a digital video recorder (DVR), and/or other on demand viewing system.

The computer system 200 may include one or more processors, such as, e.g., but not limited to, processor(s) 204. The processor(s) 204 may be coupled to and/or connected to a communication infrastructure 206 (e.g., but not limited to, a communications bus, cross-over bar, or network, etc.). Various exemplary software embodiments may be described in terms of this exemplary computer system. After reading this description, it may become apparent to a person skilled in the relevant art(s) how to implement the invention using other computer systems and/or architectures.

Computer system 200 may include a display interface 231 that may forward, e.g., but not limited to, graphics, text, and other data, etc., from the communication infrastructure 206 (or from a frame buffer, etc., not shown) for display on the display unit 230.

The computer system 200 may also include, e.g., but may not be limited to, a main memory 208, random access memory (RAM), and a secondary memory 210, etc. The secondary memory 210 may include, for example, (but not limited to) a hard disk drive 212 and/or a removable storage drive 214, representing a floppy diskette drive, a magnetic tape drive, an optical disk drive, a compact disk drive CD-ROM, etc. The removable storage drive 214 may, e.g., but not limited to, read from and/or write to a removable storage unit 218 in a well known manner. Removable storage unit 218, also called a program storage device or a computer program product, may represent, e.g., but not limited to, a floppy disk, magnetic tape, optical disk, compact disk, etc. which may be read from and written to by removable storage drive 214. As may be appreciated, the removable storage unit 218 may include a computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CD-ROM) or a digital versatile disk (DVD); a magnetic tape; and a memory chip, etc.

In alternative exemplary embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 222 and interfaces 220, which may allow software and data to be transferred from the removable storage unit 222 to computer system 200.

Computer 200 may also include an input device such as, e.g., (but not limited to) a mouse 206 or other pointing device such as a digitizer, an audio capture device 228 (such as, e.g., but not limited to, a microphone), an image video/visual capture device 232 (such as, e.g., but not limited to, a camera), and a keyboard 205 and/or other data entry device (not shown), etc.

Computer 200 may also include output devices, such as, e.g., (but not limited to) display 230 display interface 231, and/or a speaker 207, etc. Other output devices may also be used, including, e.g., but not limited to, a printer, etc. Computer 200 may include input/output (I/O) devices such as, e.g., (but not limited to) communications interface 224 and communications path 226, etc. These devices may include, e.g., but not limited to, a network interface card 202, and modem(s) 203. Communications interface 224 may allow software and data to be transferred between computer system 200 and external devices.

In this document, the terms “computer program medium” and “computer readable medium” may be used to generally refer to media such as, e.g., but not limited to removable storage drive 214, a hard disk installed in hard disk drive 212, etc. These computer program products may provide software to computer system 200. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities. Computer program products are not deemed to include pure signals in this application, but rather refer to storage devices capable of storage of computer programs and logic thereon.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another exemplary embodiment, the invention may be implemented using a combination of any of, e.g., but not limited to, hardware, firmware and software, etc.

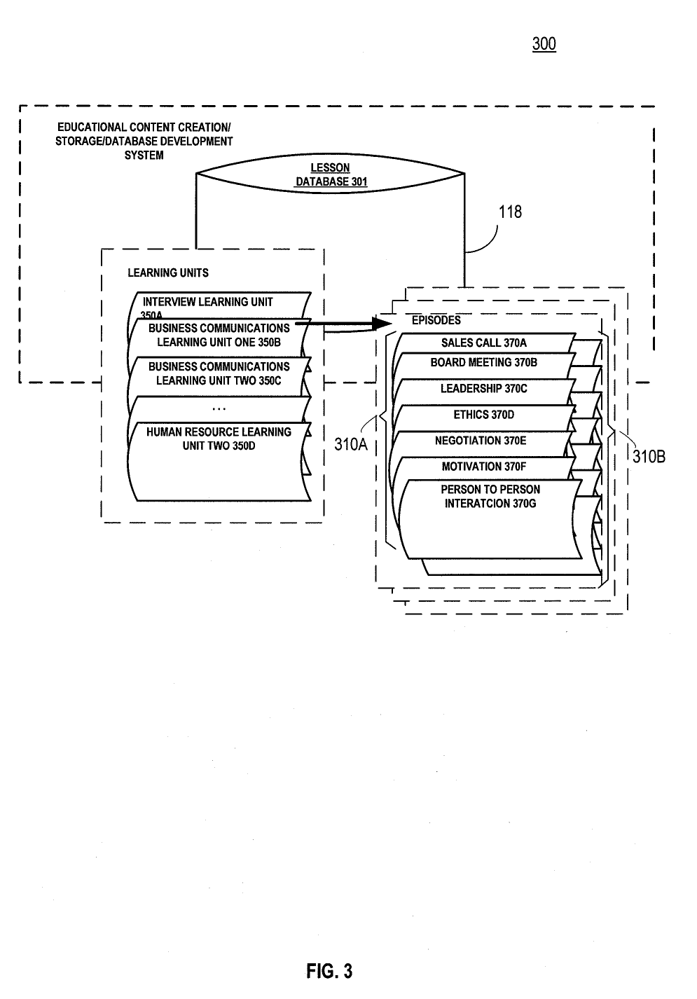

FIG. 3 depicts an exemplary embodiment of an educational content creation storage database management development system 300 as may be used to create one or more learning units 350 each of which may include one or more episodes 370 that may be used in an exemplary embodiment of the present invention. Educational content may include any of various subject matter areas including, e.g., but not limited to, language skills, native and/or foreign language, grammar, history, arts, humanities, science, social studies, and/or mathematics, etc. The learning units 350 and episodes 370 may be created by a content creator 112 using a content capture and creation device 116 which may include one or more content creation applications 114, and may use one or more hardware and/or software capture devices such as, e.g., but not limited to, an audio capture device 228 such as, e.g., a microphone, a video/visual content capture device 232 such as, e.g., but not limited to, a digital camera, a digital video camera, a scanner, etc. Specifically, FIG. 3 depicts an exemplary embodiment of a lesson database 301 that may be used, e.g., for storing data according to an exemplary embodiment of the present invention. The exemplary lesson database 301 as illustrated may contain exemplary data. The exemplary data may include learning units 350a-350k (collectively referred to as 350) and episodes 370a-370f (collectively referred to as 370). Each individual learning unit 350 may be associated with a group of episodes 310a, 310b (collectively referred to as 310). Exemplary embodiments of the present invention may include, e.g., but are not limited to, a learning unit 350 with a subject matter of business communications 350b. Exemplary embodiment business communication language learning unit 350b as illustrated may be associated with a list of exemplary episodes 310a. Exemplary embodiment episodes 310a may include, e.g., but are not limited to, a sales call 370a, a board meeting 370b, leadership episode 370c, ethics episode 370d, negotiation episode 370e, motivation episode 370f, and/or and person to person interaction 370g, etc.

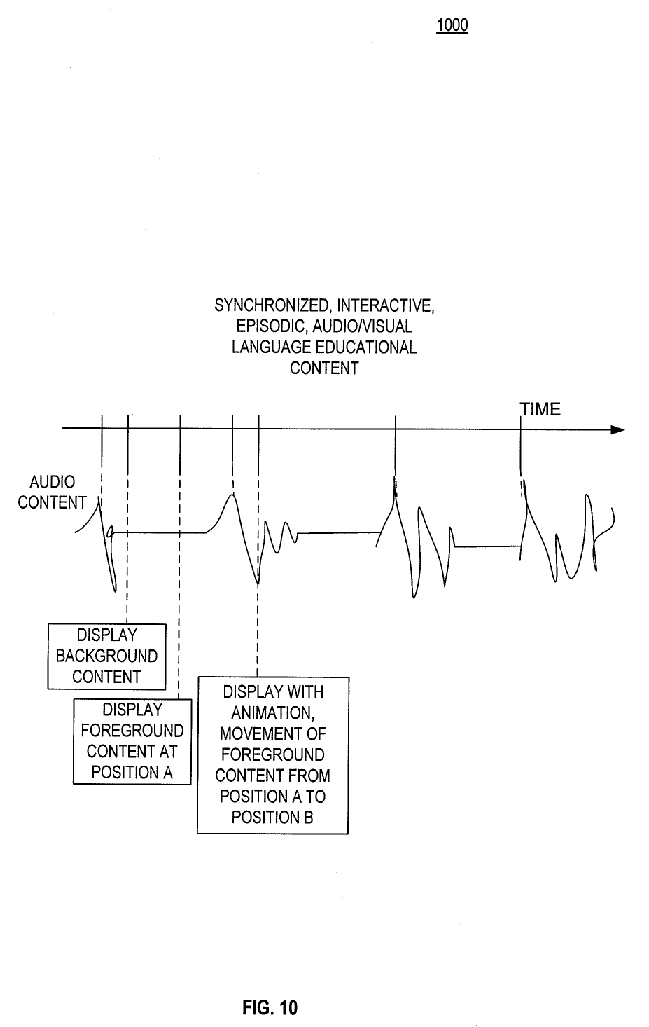

According to an exemplary embodiment, episodic language and/or other learning based content may be designed for distribution in low bandwidth environments by providing real world language training situations using low bandwidth educational content, by including, e.g., but not limited to, still image foreground content objects which may be moved from one position to another before background image content, where the foreground image content may represent one or more participants in an exemplary language training simulated interaction and/or conversation, while audio content may provide for exemplary language training in an interactive, scripted, prompt and user response computer based training environment. Content may be subscription based and/or may be one offering of a plurality of educational offerings of a cycle of learning as depicted in FIG. 10, according to an exemplary embodiment.

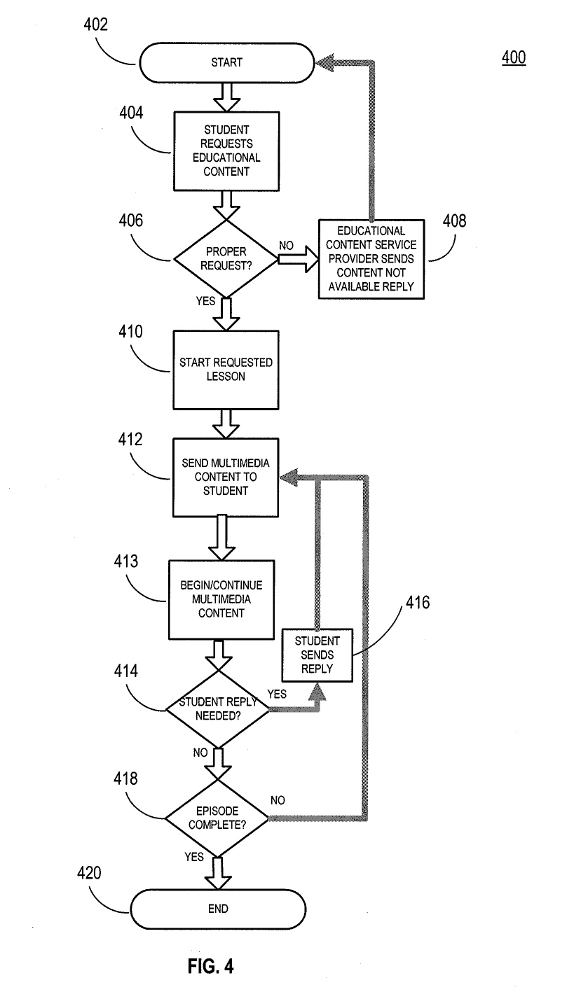

FIG. 4 depicts an exemplary embodiment of a flow diagram 400 that may begin with 402. In 402, the flow diagram 400 may begin and may proceed immediately to 404.

In 404, a student 102 may request educational content such as, e.g., but not limited to, episodic language training educational content in the form of an episode 370 from the educational service provider 124. From 404, the flow diagram 400 may proceed to 406.

In 406, the exemplary educational content service provider 124 may determine, e.g., if the request of student 102 for educational content was proper. If the request in 406 is not proper then the flow diagram 400 may proceed to 408. If the request is deemed proper, flow diagram 400 may continue with 410.

In 408, the educational content service provider 124 may send a reply to the student device 106, where an exemplary replay might include, e.g., but not limited to, a content not available reply. From 408, the flow diagram 400 may proceed back to 402.

If the request in 406 is deemed proper, then the flow diagram 400 may then proceed to 410. In 410, in an exemplary embodiment, the educational content service provider may retrieve an exemplary lesson 350 for interactive access by the student. In an exemplary embodiment, the educational service provider may position content closer to the student device 106 so that the content may be delivered more quickly. Services which may position content closer to the student device 106 may be provided by, for example, Akamai Technologies, Inc. of Cambridge, Mass. From 410, the flow diagram 400 may proceed to 412.

In 412, the educational content service provider 124 may send exemplary multimedia content, according to an exemplary embodiment, in the form of the requested lesson 350 to the student device 106 to be viewed and/or interacted with by student 102. The multimedia content may be sent in one or more segments depending on bandwidth usage goals and/or restrictions. For example, a foreground image may be transmitted to a student device 106 separately and/or simultaneously with a background image and/or audio content. In one exemplary embodiment, the content maybe assembled prior to transmission. According to one exemplary embodiment, content may be assembled by one or more assembly techniques. According to one exemplary assembly technique, a depth of field and/or camera movement maybe provided to provide an exemplary simulated three (3)-dimensional picture. In an exemplary embodiment, assembly software such as, e.g., but not limited to, Adobe After Effects software available from Adobe Systems Incorporated of San Jose, Calif., USA may be used. In an exemplary embodiment, the multimedia content may be a movie and/or static image file and/or may be transmitted in one or more segment(s). Foreground images, background images, and/or audio content are discussed in further detail below. From 412, the flow diagram 400 may proceed to 413.

In 413, the student may begin and/or continue viewing, interacting, and/or listening to the multimedia content. According to one exemplary embodiment, the student may begin and/or continue the multimedia content by, e.g., but not limited to, listening to a model recording of a word or phrase via speaker 207. The student may then repeat the word or phrase, which may be recorded by an audio capture device 228. A recording of the student reading the word or phrase may be stored on the student device 106 and/or the educational content service provider 124. The student may then listen to the model recording of the word or phrase via a speaker 207. The student may then listen to a recording of the student repeating the word or phrase via speaker 207. According to another exemplary embodiment, the student may begin and/or continue the multimedia content by, e.g., but not limited to, reading a model word or phrase. The word or phrase may be displayed on a display 230. The student may then read the word or phrase. The word or phrase read by the student may be recorded by an audio capture device 228. A recording of the student reading the word or phrase may be stored on the student device 106 and/or the educational content service provider 124. The student may then listen to a model recording of the word or phrase via a speaker 207 The student may then listen to the recording of the student reading the word or phrase via speaker 207. The model word or phrase may be, e.g., but not limited to, part of a sentence and/or part of a role playing activity involving one or more people. From 413, the flow diagram 400 may proceed to 414.

In 414, if a student reply is desired, the flow diagram 400 may move to 416. Alternatively, if a student reply is not desired, the flow diagram 400 may continue to 418.

In 416, the student may send a reply through the student device 106 to the educational content service provider 124. The student reply may be sent via an input device such as, e.g., (but not limited to) a mouse 206 or other pointing device such as, e.g., but not limited to, a digitizer, an audio capture device 228, a video/visual capture device 232, a keyboard 205, an audio and/or other data entry devices. From 416 the flow diagram may then proceed to 412. If in 414, there is no need for a student reply, the flow diagram may proceed to 418.

In 418, if the episode is not complete (i.e. multimedia content may still be transmitting from the educational content service provider), then the flow diagram 400 may continue with 412. If in 418, it may be determined that the episode is complete (i.e., e.g. but not limited to, the educational service provider has no more multimedia content to send), then the flow diagram 400 may proceed with 420.

In 420, the lesson may be presumed complete and the flow diagram 400 may end, according to one exemplary embodiment.

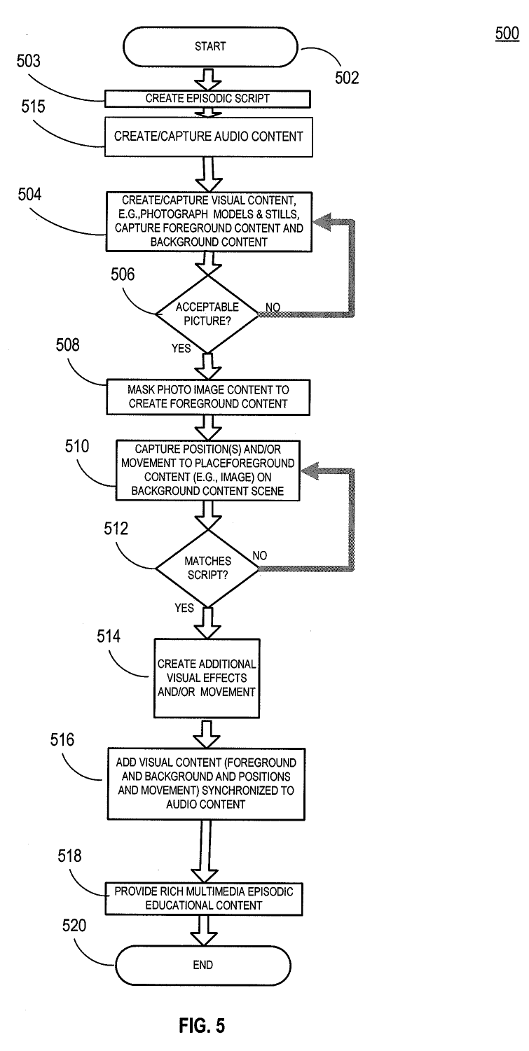

FIG. 5 depicts an exemplary embodiment of a content creation flow diagram 500, according to an exemplary embodiment that may begin with 502. In 502, the flow diagram 500 may begin and may proceed immediately to 503.

In 503, according to an exemplary embodiment, an educational content episodic script may be created. According to one exemplary embodiment, a story board may be created. According to another exemplary embodiment, a textual based description of an exemplary verbal interaction on a topic of the episode between two or more persons may be described. From 503, flow diagram 500 may proceed with 515 in an exemplary embodiment.

In 515, in an exemplary embodiment, audio content may be created and/or captured. From 515, flow diagram 500 may continue with 504.

In 504, according to an exemplary embodiment, an image may be captured and/or created. An image may be captured, such as, for example, a photograph 680,taken via, e.g., but not limited to, a digital camera, a camera, a video camera, and/or other image capture device as will be well known to those of skill in the art. An image may be created, for example, via a computer, a scanner, and/or an image capture device, etc. The image may contain one or more people such as models (not shown) for use later as a foreground image 682, 882 to be placed on a given background image content 795, 895, as shown in 802. From 504, the flow diagram 500 may continue with 506.

In 506, if the image captured in 504 are acceptable then the flow diagram 500 may proceed to 508, according to an exemplary embodiment. If the image content (e.g., photographs) taken in 504 are not found acceptable, then the flow diagram 500 may proceed back to 504 to capture or create additional imagery.

In 508, the images and/or portions of the images and/or photographs may be masked 681 to extract foreground content images 682a, 682b, 682c (collectively referred to as 682) to create foreground content images 682, according to an exemplary embodiment. Alternatively, where the image is created, for example, via a computer, the foreground and/or background images may be created separately. From 508, the flow diagram 500 may proceed to 510.

In 510, the masked image 682 may be placed on a background image 795, 895 to produce a series of scenes 802a, 802b, 802c (collectively referred to as 802), which may correspond to successive stages of the episodic script, according to an exemplary embodiment. In 510, according to an exemplary embodiment, an initial position of a foreground image may be captured. Further, successive positions of the foreground image may be captured as well, so as to enable movement of the foreground image relative to the background image, so as to animate, in a primitive manner, the movement of the fixed image foreground image representation of a participant in a verbal interaction in the educational episodic content. From 510, the flow diagram 500 may proceed with 512.

In 512, if the scene 802 is determined to not match the script or to be in need of further animation, modification, or change in position of the elements so as to simulate the interaction being trained, the flow diagram 500 may proceed to 510 to continue to be modified to create the scene being simulated as part of the script, according to an exemplary embodiment. In 512, if the scene 802 does match a script then the flow diagram may proceed to 514.

In 514, any additional visual effects, audio effects, delay, content, and/or movement may be added to the scene, according to an exemplary embodiment. From 514, the flow diagram 500 may continue with 516.

In 516, according to an exemplary embodiment, visual effects and/or simulated movement may be added to the scene. For example, according to an exemplary embodiment, visual content may be added including, e.g., but not limited to, placement of foreground image content atop background image content, as well as positioning, and movement of objects and any synchronization and triggers based on audio content and a script. From 516, the flow diagram 500 may proceed to 516.

In 516, audio may be synchronized with the visual imagery to produce rich multimedia episodic educational content ready to be distributed to one or more students. From 516, the flow diagram may continue with 518.

In 518, the rich multimedia episodic educational content may be complete and may be prepared such as, e.g., but not limited to, aggregated, compressed, prepare for distribution, etc. In one exemplary embodiment, the content may be assembled using a software tool such as, e.g., but not limited to, Adobe After Effects available from Adobe Systems Incorporated of San Jose, Calif., USA. From 518, flow diagram 500 may proceed to 520, and flow diagram 500 may continue immediately to end.

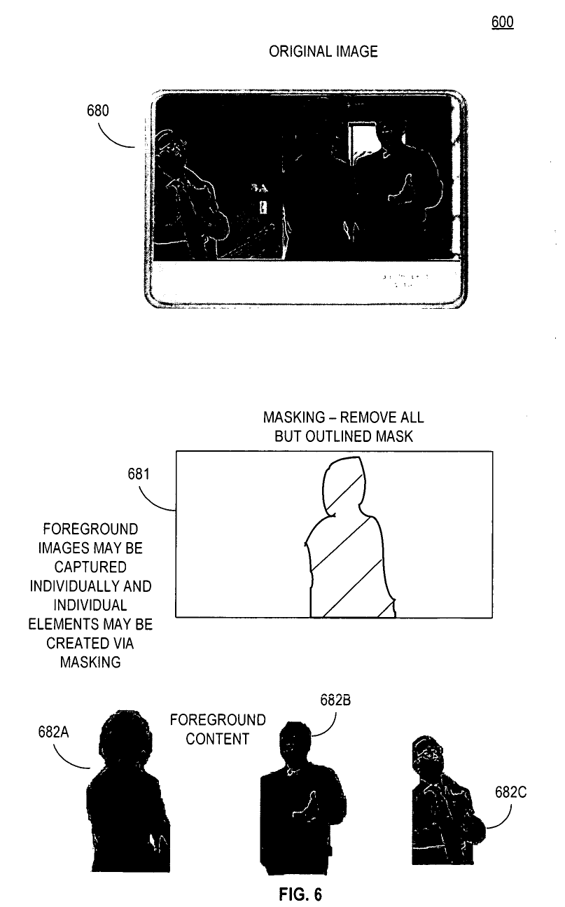

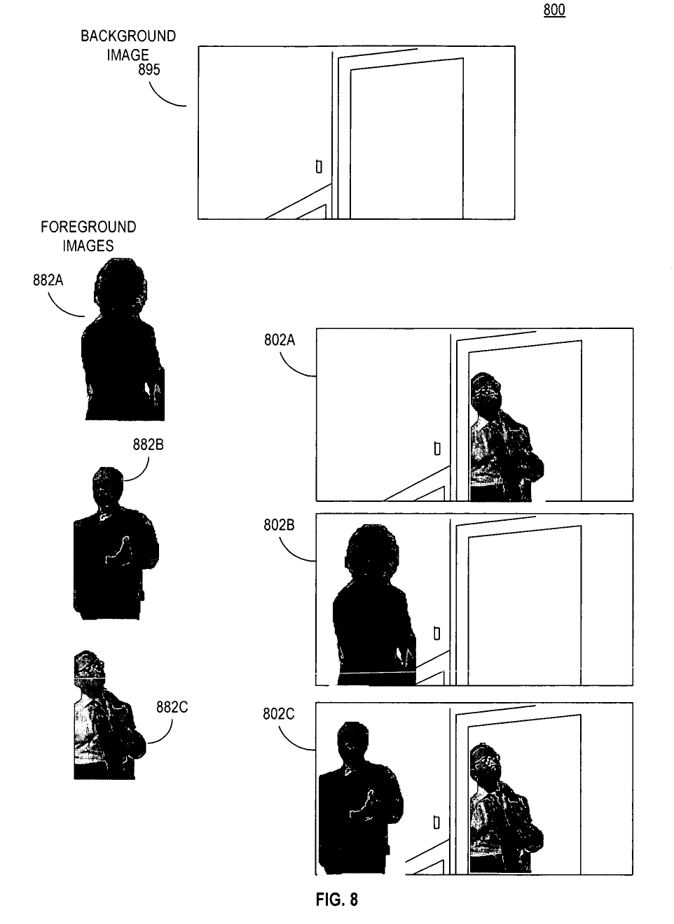

FIG. 6 depicts an exemplary embodiment of an exemplary process for the creation of exemplary foreground images 682a, 682b, and 682c (collectively referred to as 682) according to an exemplary embodiment of the present invention. An exemplary embodiment of an original image 680 may be photographed to form an exemplary scene. Using masking, exemplary foreground images 682 may be extracted from the exemplary image 680. The exemplary image may be masked using an exemplary mask 681 as shown in an exemplary embodiment, which may allow for the extraction of foreground images 682 from the original image 680. According to an exemplary embodiment, the foreground images 682a, 682b, 682c may be used as exemplary characters in an episodic educational content storyline. According to an exemplary embodiment, the foreground images 682 may be placed onto a background image as shown in 802a, 802b, and 802c of FIG. 8, for example.

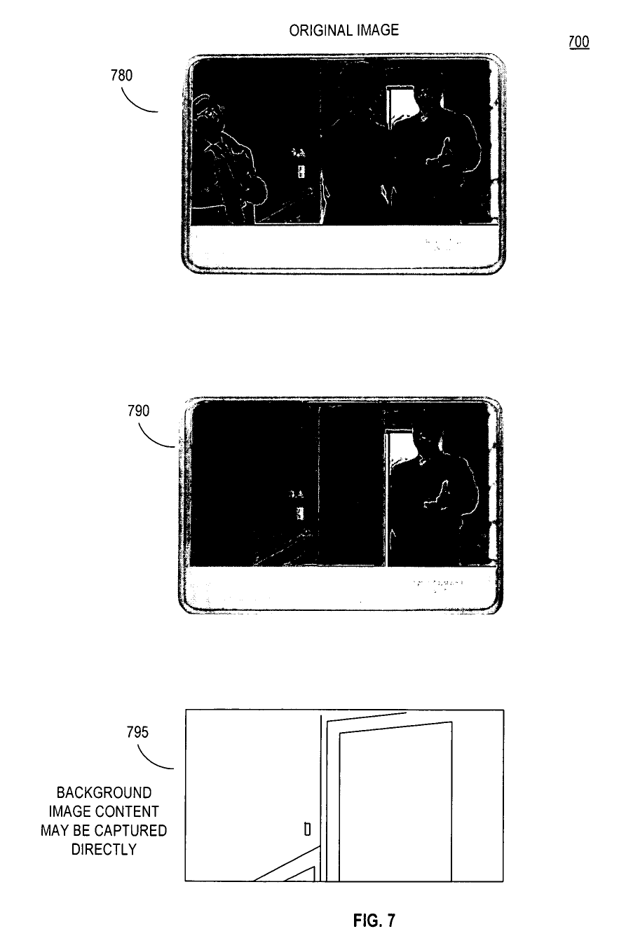

FIG. 7 depicts an exemplary embodiment of various exemplary embodiments of how to capture one or more background images 780, 790, 795, according to an exemplary embodiment of the present invention. One exemplary background image 780 may depict a scene with three characters in the foreground. Another exemplary background image 790, with the same background image as 780, may depict a scene with only one character. Another exemplary background image 795 may depict a background image with no characters. Background exemplary images such as, e.g., but not limited to, 780, 790, 795, may be used to simulate an interaction between one or more characters in an episodic learning content with the student viewer. According to an exemplary embodiment, the background content may be used to provide a scene and the foreground images may simulate the action being represented in an exemplary episode, so as to introduce, e.g., locations into the storyline. In another exemplary embodiment (not shown), the background of a boardroom, etc., could be used to set the stage for a business meeting episodic interaction educational content learning application.

FIG. 8 depicts an exemplary assembly technique including various exemplary foreground images 882a, 882b, and 882c (collectively referred to as 882) are placed onto an exemplary background image 895, according to the present invention, thereby creating three distinct scenes. The same exemplary background image 895 can serve as the background for various scenes by changing the foreground images, or locations of the foreground images relative to one another, or on the background image as exemplified in 802a, 802b, and 802c. According to another exemplary embodiment the same foreground image 882 can be placed in multiple background images (not shown) creating new scenes. According to an exemplary embodiment, the location of a foreground image on the background image may change over time in synchronization with a script and/or audio timing. According to an exemplary embodiment, various foreground images may be placed at least partially overlapping one another so as to create a simulated three (3)-dimensional effect. An exemplary assembly technique may create a depth of field which may also allow for camera movement, to provide a simulated three (3)-dimensional picture. An exemplary assembled animation/movie content may be generated, which may be transmitted to a user, such as, e.g., a student, for viewing. A single frame instant of the animation/movie may appear as shown in image 680.

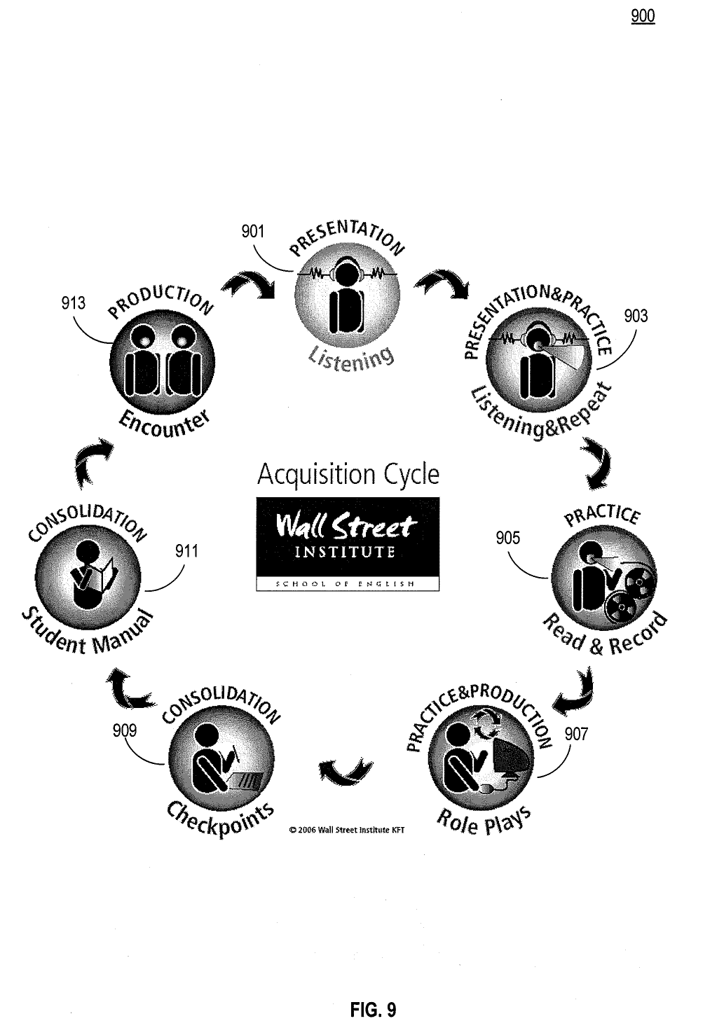

FIG. 9 depicts an exemplary learning cycle that may be used in implementing an exemplary embodiment of the present invention. Specifically, FIG. 9 depicts an exemplary embodiment of an educational process by which a student may learn from rich educational multimedia episodic content 900 that may be used in various lessons such as, e.g., but not limited to, how to interview, making a sales call, etc., according to an exemplary embodiment of the present invention. According to an exemplary embodiment, in 901, a student 102 may listen to rich educational multimedia episodic content. According to an exemplary embodiment, in 903, a student 102 may listen to rich educational multimedia episodic content and may repeat the spoken audio. According to an exemplary embodiment, in 905, a student 102 may read the text of rich educational multimedia episodic content and may record the students' spoken words. According to an exemplary embodiment, in 907, a student 102 may interact with the rich educational multimedia episodic content and may play out a particular role, which could include, but may be not limited to, e.g., interacting with a person or persons, making a sales call, interviewing for a job, and/or interacting with a receptionist, etc. According to an exemplary embodiment, in 909, a student 102 may review checkpoints. According to an exemplary embodiment, in 911, a student 102 may read a student manual. According to an exemplary embodiment, in 913, a student 102 may practice what was learned in the episodic lessons by having a live encounter with a facilitator and/or a group of other students and/or faculty to allow for practice of the skills learned. The cycle may begin again in 901 with a new episode representing a lesson.

FIG. 10 depicts an exemplary embodiment of a diagram 1000 illustrating an exemplary delivery of exemplary episodic educational language learning based content including providing audio content 1002 and display of visual content, including background 1004 and foreground 1006, including in an exemplary embodiment, animation 1008 including, e.g., movement of foreground image content 682 relative to exemplary background image content 695 including exemplary time synchronized, interactive, episodic, audio-visual language content, depicted as graphed with respect to time. Audio content may be synchronized with the still image visual content achieving a low bandwidth simulation of a video interaction without the need to transmit the usual 30 frames per second of video frame image content to achieve a simulated, animated visual and audio rich multimedia learning experience for a student. The provision of such training is especially helpful in nations where communications infrastructure is still immature, as well as where higher bandwidth communication is unavailable because of cost or other reasons. Interactions with the student via the episodic learning may include, in an exemplary embodiment, prompted questioning, verbal prompts, textual prompts, questions, requests for answers, etc.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method of delivering educational content comprising:
(a) receiving and storing rich multimedia episodic educational content; and
(b) distributing said rich multimedia episodic educational content comprising:
(i) transmitting at least one background image,
(ii) transmitting at least one foreground image,
(iii) transmitting audio content, and
(iv) transmitting at least one display location to display said at least one foreground image in front of said at least one background image in synchronization with said audio content.

2. The method of claim 1, wherein said (b) comprises at least one of:
transmitting from an educational content service provider device to at least one student device;
transmitting wherein at least two of said (i), said (ii), said (iii), and/or said (iv) are assembled together prior to transmission and are transmitted together in at least one of a movie format and/or a static image format;
varying the size of said (b) depending on delivery bandwidth;
distributing at least one learning unit to at least one student;
prompting by said educational service provider device a reply from said student device according to an interactive script, wherein said prompting comprises said educational content provider device waiting for said reply from said student device before continuing distributing said content;
transmitting by student device a response to said educational content service provider device said prompting after receiving input from said student through an input device from at least one input device such as a keyboard and/or mouse; and/or waiting, wherein said waiting comprises resuming said distribution of said script to said student device when said response from said student device is received by said educational content service provider device.

3. The method of claim 1, wherein said (a) comprises receiving and storing rich multimedia episodic language educational content.

4. The method of claim 3, wherein said (a) comprises at least one of:
(i) receiving and storing rich multimedia episodic English language educational content;
(ii) receiving and storing rich multimedia episodic foreign language educational content;
(iii) receiving and storing rich multimedia episodic language educational content providing executive interactive episodes including real world interactions including any combination of: a job interview, a sales call, an employee and employer interaction, a person to person interaction, interacting with a receptionist, a student and teacher interaction, a purchaser and salesperson interaction, travel-related interactions, and/or a person to person business interation; and/or
(iv) receiving and/or storing rich multimedia episodic language educational content comprising targeted learning objectives.

5. The method of claim 1, further comprising:
(c) creating said rich multimedia episodic language educational content.

6. The method of claim 5, wherein said (c) comprises creating interactive episodic scripts that meet learning objectives.

7. The method of claim 6, wherein said (c) comprises at least one of:
(i) developing said interactive episodic scripts to teach at least one of grammar, vocabulary, and/or language nuances;
(ii) developing said interactive scripts to teach at least one of English grammar, vocabulary, and/or language nuances;
(iii) tailoring said interactive scripts to develop business language skills;
(iv) providing a learning unit comprising a plurality of said scripts; and/or
(v) capturing said audio content comprising recording audio based upon said scripts.

8. The method of claim 7, wherein said (c)(v) comprises at least one of:
(A) combining said audio content with at least one of said images;
(B) creating animated sequences of at least one of said images matching said scripted audio; and/or
(C) capturing at least one of a voice sound track, a conversation, an inquiry, a prompt, a query, a dialog, a sound effect, and/or music.

9. The method of claim 5, wherein said (c) comprises at least one of
(i) capturing at least one of said images comprising photographing human models;
(ii) capturing at least one of said foreground images comprising at least one of, photographing, masking, and/or assembling for placing on said at least one background image matching a script;
(iii) creating visual effects, movement and/or timing a sequence matching said audio content; and/or
(iv) optimizing file size and quality for said delivering comprising efficient transmitting over a medium such as the Internet by compressing said rich multimedia episodic language educational content.

10. The method of claim 2, further comprising receiving a reply from said student device at said educational content service provider device.

11. A method of receiving educational content comprising:
(a) receiving rich multimedia episodic educational content comprising:
(i) receiving at least one background image,
(ii) receiving at least one foreground image,
(iii) receiving audio content, and
(iv) receiving at least one display location to display said at least one foreground image in front of said at least one background image in synchronization with said audio content; and
(b) displaying said rich multimedia episodic educational content comprising:
(i) playing said audio content, and
(ii) displaying at said at least one display location said at least one foreground image in front of said at least one background image in synchronization with said audio content.

12. The method of claim 11, wherein said a) comprises receiving, wherein at least two of said (i), said (ii), said (iii), and/or said (iv) are assembled together prior to transmission and are received together in at least one of a movie format and/or a static image format.

13. The method of claim 11, further comprising:
(c) storing said rich multimedia episodic educational content.

14. The method of claim 11, wherein said content is received from an educational content service provider at a student device.

15. The method of claim 11, wherein said (b) comprises displaying and/or moving said at least one foreground image in relation to said at least one background image to give the appearance of motion in synchronization with said audio.

16. The method of claim 14, wherein said (a) comprises at least one of
(v) requesting said learning unit from said educational content service provider device;
(vi) receiving said learning unit from said educational content service provider device; and/or
(vii) receiving said rich multimedia episodic educational content from a said educational content service provider device.

17. The method of claim 11, wherein said (a) comprises at least one of:
(v) receiving and/or storing rich multimedia episodic language educational content;
(vi) receiving and storing rich multimedia episodic English language educational content;
(vii) receiving and/or storing rich multimedia episodic foreign language educational content;
(viii) receiving and/or storing rich multimedia episodic language educational content providing executive interactive episodes including real world interactions including any combination of: a job interview, a sales call, an employee and employer interaction, a person to person interaction, interacting with a receptionist, a student and teacher interaction, a purchaser and salesperson interaction, a travel-related interaction, and/or a person to person business interation; and/or
(ix) receiving and/or storing rich multimedia episodic language educational content comprising targeted learning objectives.

18. A system for delivering educational content comprising:
(a) means for receiving and storing rich multimedia episodic educational content; and
(b) means for distributing said rich multimedia episodic educational content comprising:
(i) means for transmitting at least one background image,
(ii) means for transmitting at least one foreground image,
(iii) means for transmitting audio content, and
(iv) means for transmitting at least one display location to display said at least one foreground image in front of said at least one background image in synchronization with said audio content.

19. A computer readable storage medium having computer logic embodied therein which when executed on a computer processor enables a method comprising:
(a) receiving and storing rich multimedia episodic educational content; and
(b) distributing said rich multimedia episodic educational content comprising:
(i) transmitting at least one background image,
(ii) transmitting at least one foreground image,
(iii) transmitting audio content, and
(iv) transmitting at least one display location to display said at least one foreground image in front of said at least one background image in synchronization with said audio content.
